(19) United States
(12) Patent Application Publication
(10) Pub. No.: US 2021/0150753 A1
(43) Pub. Date: May 20, 2021

(54) OBJECT TRACKING METHOD BASED ON IMAGE

(71) Applicants: INVENTEC (PUDONG) TECHNOLOGY CORPORATION, Shanghai City (CN); INVENTEC CORPORATION, Taipei City (TW)

(72) Inventor: Jiun-Kuei JUNG, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 16/721,353

(22) Filed: Dec. 19, 2019

(30) Foreign Application Priority Data
Nov. 19, 2019 (CN) 201911136696.X

(51) Int. Cl. G06T 7/73; G06T 7/11; G06T 7/174

(52) U.S. Cl. CPC G06T 7/73; G06T 7/174; G06T 7/11

(57) ABSTRACT

An object tracking method based on image, comprising: identifying an object in an image and determining whether the object is a target object, determining whether the target object is located within a region of interest in the image when the object is the target object, and generating a coordinate information and a time information to track the target object when the target object is located within the region of interest.

### CROSS-REFERENCE TO RELATED APPLICATIONS

This non-provisional application claims priority under 35 U.S.C. § 119(a) on Patent Application No(s). 201911136696 filed in China on Nov. 19, 2019, the entire contents of which are hereby incorporated by reference.

### BACKGROUND

1. Technical Field

This disclosure relates to an object tracking method based on image, and more particularly, to an object tracking method based on image that effectively saves computational load.

### 2. Related Art

As the needs of monitoring technology based on image become more diverse and changeable, coupled with the complexity of the monitoring site itself, the application of fixed surveillance picture can no longer meet the user's needs. Accordingly, the technology of intelligent video surveillance (IVS) came into being. The intelligent video surveillance technology includes issuing a warning notice to the security center when an abnormal event is detected.

The development of intelligent video surveillance has reached to a certain extent. However, other monitoring needs, for example, having multiple regions of interest in the same monitoring image, and detecting different events in different regions of interest are difficult to implement. Also, detecting different events at the same time hugely increases the computational load of the monitoring system, which makes the application of edge computing more difficult.

The advantage of edge computing is that it can greatly reduce the occupation of network bandwidth since the edge computing device only needs to transmit the most important computing result (such as the detection result obtained by the intelligent video surveillance system) to the cloud host via the network. However, the cost of setting up edge computing devices increases when the computational load is too large; conversely, the advantages of edge computing is lost if the computing operation are sent back to the cloud host to reduce the cost of setting up edge computing devices. Therefore, it is necessary to reduce the computational load of the intelligent video surveillance system.

### SUMMARY

According to one or more embodiment of this disclosure, an object tracking method based on image, comprising: identifying an object in an image and determining whether the object is a target object; determining whether the target object is located within a region of interest in the image when the object is the target object; and generating a coordinate information and a time information to track the target object when the target object is located within the region of interest.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of an object tracking method based on image according to an embodiment of the present disclosure;

FIG. 2 is a flow chart of an object tracking method based on image according to a first embodiment of the present disclosure;

FIG. 3 is a flow chart of an object tracking method based on image according to a second embodiment of the present disclosure;

FIG. 4 is a flow chart of an object tracking method based on image according to a third embodiment of the present disclosure;

FIG. 5 is a flow chart of an object tracking method based on image according to a fourth embodiment of the present disclosure;

FIG. 6 is a flow chart of an object tracking method based on image according to a fifth embodiment of the present disclosure;

FIG. 7 is a flow chart of an object tracking method based on image according to a sixth embodiment of the present disclosure; and

FIG. 8 is a flow chart of an object tracking method based on image according to a seventh embodiment of the present disclosure.

### DETAILED DESCRIPTION

The object tracking method based on image disclosed in one or more embodiments of the present disclosure is preferably performed by an edge computing device communication connected to the surveillance center. The object tracking method based on image disclosed in one or more embodiments of the present disclosure can also be performed by devices that are capable of computing such as a server or central processing unit of the surveillance center. The monitoring center can be a traffic monitoring center that monitors streets or highways, a monitoring center that monitors the flow of people in indoor or outdoor spaces, or a monitoring center that monitors animals in the wild or in the farm, the present disclosure is not limited thereto. In addition, the object tracking method based on image of the present disclosure can be used to transmit the result of tracking to a cloud monitoring center by an edge computing framework to further compute the result of tracking.

For the convenience of illustrating the embodiments of the present disclosure, the object tracking method based on image using an edge computing device, which is communication connected to a traffic monitoring center, is taken as an example.

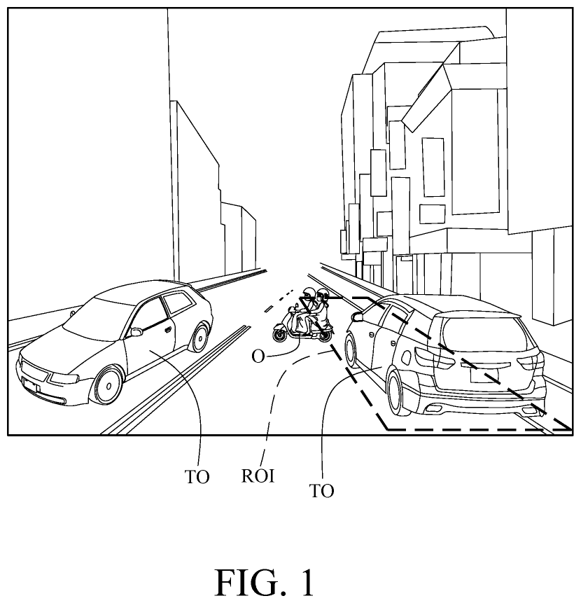

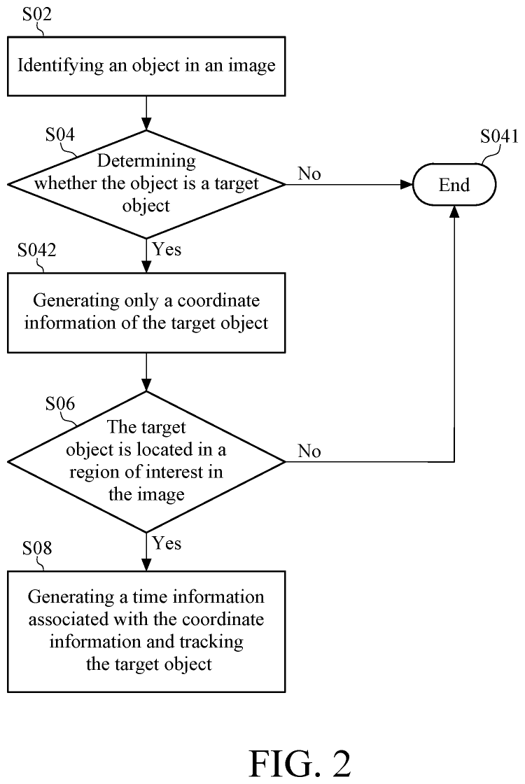

Please refer to both FIGS. 1 and 2, wherein FIG. 1 is a schematic diagram of an object tracking method based on image according to an embodiment of the present disclosure; and FIG. 2 is a flow chart of an object tracking method based on image according to a first embodiment of the present disclosure.

Please refer to step S02: identifying an object in an image. The image is, for example, obtained by a camera that captures the scenes of the road, and the image (as shown in FIG. 1) can have one or more unidentified objects O. For example, the unidentified objects O can include vehicles, motorcycles, bicycles, buses and pedestrians, etc. Identifying the objects O in the image can be performed by artificial intelligence (AI) technology.

Please refer to step S04: determining whether the object is a target object. Specifically, in step S04, the edge computing device determines whether the object O such as the above-mentioned vehicle, motorcycle, bicycle, bus, and pedestrian, etc. is the target object TO to be tracked. The number of target object TO can be one or more. For better understanding, the present embodiment use vehicle as the target object TO as an example, the present disclosure is not limited thereto.

Please refer to step S041, S042 and S06 together. The edge computing device ends the method in step S041 when every object O in the image is not the target object TO. Conversely, the edge computing device identify a coordinate information of the target object TO when the object O is the target object TO (meaning at least one object O is the target object TO), to subsequently determine whether the target object TO is located in a region of interest (a monitoring area) ROI in the image in step S06. When the image is, for example, an image of a street scene obtained by the camera, the region of interest ROI can be a lane, parking area, intersection, etc. in the street scene, and the edge computing device can determine whether the target object TO is located within the region of interest ROI based on the coordinate information of the target object TO.

Please continue referring to step S06. To be more specific, the edge computing device determines whether the target object TO is located within the region of interest ROI is, for example, determining whether the coordinate information of the target object TO falls within a coordinate range of the region of interest ROI. The coordinate range is preferably located within a plurality of coordinate points, and lines connecting the coordinate points constitute the enclosed range of the region of interest ROI. The number of region of interest ROI can be one or more, meaning there can be one or more regions of interest ROI in one image, and any two regions of interest ROI are preferably separated from each other, the present disclosure is not limited thereto.

In the present embodiment, the edge computing device ends the method in step S041 when the edge computing device determines in step S06 that the target object TO is not located within the region of interest ROI. Conversely, the edge computing device further generates a time information associated with the coordinate information in step S08 when the edge computing device determines in step S06 that the target object TO is located within the region of interest ROI. The edge computing device then records the coordinate information and the time information to track the target object TO.

Please continue referring to step S08. Specifically, the coordinate information preferably is the coordinate location of the target object TO in the image; the time information preferably is the time point when the target object TO is at the coordinate location. Therefore, when the target object TO is located within the region of interest ROI, the coordinate information and the time information of the target object TO generated by the edge computing device can be used to track the location of the target object TO in the region of interest ROI. Meaning, the edge computing device can determine the location and time of presentation of the target object TO within the region of interest ROI according to the coordinate information and the time information of the target object TO in the image. In addition, when the edge computing device collects more than one image, the edge computing device further tracks the target object TO based on the images. Therefore, when the target object TO is located within the region of interest ROI, then the coordinate information and the time information of the target object TO recorded by the edge computing device in each image can further be used to track the moving path, dwell time, moving time and speed of the target object TO within the region of interest ROI, the present disclosure is not limited thereto.

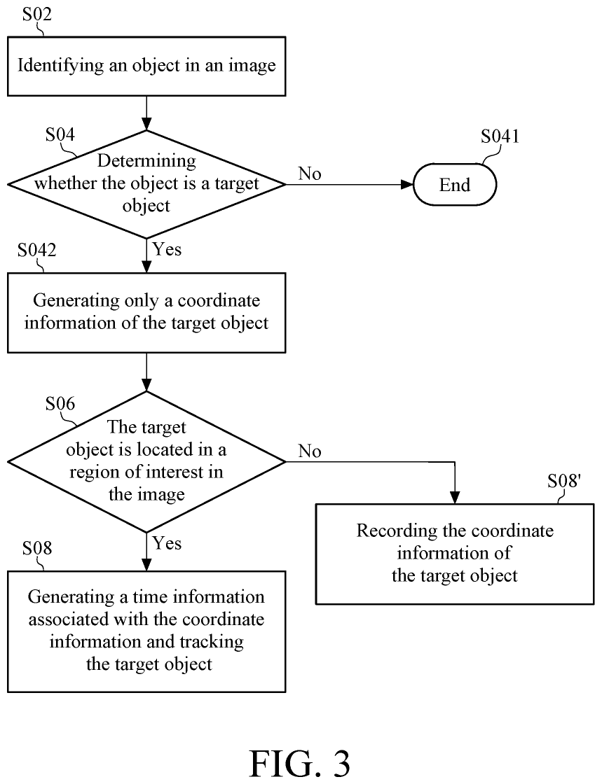

Please refer to FIG. 3. FIG. 3 is a flow chart of an object tracking method based on image according to a second embodiment of the present disclosure. Steps S02 to S08 disclosed in FIG. 3 are the same as steps S02 to S08 disclosed in FIG. 2, which won't be further illustrated herein.

FIG. 3 is different from FIG. 2 in that, when the edge computing device determines that the target object TO is not located within the region of interest ROI in step S06 of FIG. 3, the edge computing device records the coordinate information of the target object TO in step S08′. In other words, when the target object TO in the image is not located within the region of interest ROI, that means the edge computing device can record the coordinate information of the target object TO and does not need to track the target object TO. Accordingly, the computational load and time of the edge computing device used on tracking the target object TO can be effectively reduced.

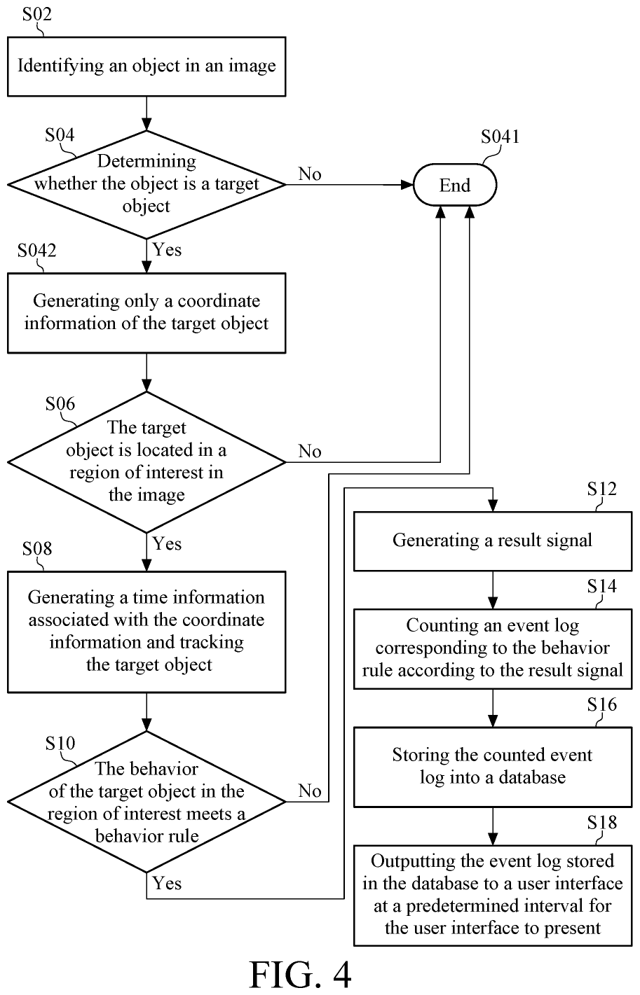

Please refer to FIG. 4. FIG. 4 is a flow chart of an object tracking method based on image according to a third embodiment of the present disclosure. Steps S02 to S08 disclosed in FIG. 4 are the same as steps S02 to S08 disclosed in FIG. 2, which won't be further illustrated herein.

FIG. 4 is different from FIG. 2 in that, when the edge computing device performs step S08 on multiple images to generate multiple coordinate information and time information associated with the target object, the edge computing device can further determine in step S10 whether the behavior of the target object in the region of interest meets a behavior rule. When the behavior of the target object in the region of interest meets the behavior rule, the edge computing device generates the result signal in step S12; conversely, when the behavior of the target object in the region of interest fails to meet the behavior rule, the edge computing device ends the method.

Please continue referring to step S10 and S12 disclosed in FIG. 4 and take the above-mentioned street scene as an example. When the region of interest is a lane in the street scene, then the behavior rule can be a preset moving direction of the lane. In other words, the edge computing device can determine the moving direction of the vehicle (target object) in the lane (region of interest), so as to obtain the amount of vehicles in the region of interest that are moving in the preset moving direction (behavior rule). The result signal preferably includes the amount of vehicles that are moving in the preset moving direction (behavior rule), the present disclosure is not limited thereto.

Please continue referring to FIG. 4, wherein after generating the result signal in step S12, the edge computing device further counts an event log corresponding to the behavior rule according to the result signal in step S14, and stores the counted event log into a database in step S16.

Please continue referring to step S14 of FIG. 4 and take the traffic flow in the above-mentioned street scene as an example. When the result signal includes the amount of vehicles that meet the behavior rule, the edge computing device can further count the traffic flow data to the event log that corresponds to the behavior rule. In the present example, the event log is the cumulative number of target objects that meet the behavior rule in the region of interest. Meaning, when the moving direction of a vehicle meets the preset moving direction (behavior rule) of the lane, the result signal can include the information of the vehicle. The edge computing device can add “1” to the event log corresponding to the preset moving direction (behavior rule) according to the result signal.

Please continue referring to step S16 of FIG. 4. The execution of “storing the counted event log into the database” is not limited to creating an event log in the database. The execution of “storing the counted event log into the database” also includes updating the event log that is already stored in the database.

Please refer to step S18 of FIG. 4: outputting the event log stored in the database to a user interface at a predetermined interval for the user interface to present. To be more specific, after completing the counting of the event log in step S14 and storing the counted event lot into the database in step S16, the edge computing device can further query the event log stored in the database at the predetermined interval for the user interface to present. The predetermined interval can be, for example, 15 minutes, 1 hour, or 8 hours, the present disclosure is not limited thereto.

Please continue referring to FIG. 4. It is worth noticing that, step S14 to S18 are preferably performed after the result signal is generated (step S12). However, if there is no need for recording the behavior of the target object, then the present embodiment can also be realized with ending the method after the result signal is generated (step S12), the present disclosure is not limited thereto. In addition, the present embodiment preferably includes step S18. However, if the event log stored in the database is merely used for subsequent data analysis and not for users to review, step S18 of the present embodiment can also be dismissed. The present disclosure is not limited thereto.

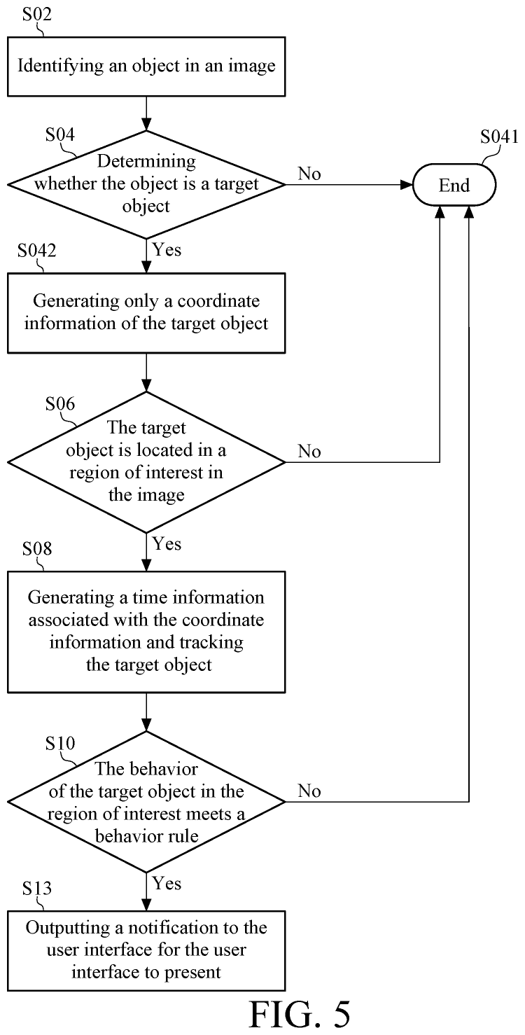

Please refer to both FIGS. 4 and 5, wherein FIG. 5 is a flow chart of an object tracking method based on image according to a fourth embodiment of the present disclosure. Steps S02 to S10 disclosed in FIG. 5 are the same as steps S02 to S10 disclosed in FIG. 4, which won't be further illustrated herein.

FIG. 5 is different from FIG. 4 in that, for the embodiment disclosed in FIG. 5, when the edge computing device in step S10 determines that the behavior of the target object in the region of interest meets the behavior rule, the edge computing device outputs a notification to the user interface for the user interface to present in step S13. However, the implementation of the present embodiment can also be: when the edge computing device determines in step S10 that the behavior of the target object in the region of interest fails to meet the behavior rule, the edge computing device outputs a notification to the user interface for the user interface to present in step S13.

Please continue referring to FIG. 5 and take the above-mentioned moving direction as the behavior rule as an example. In the embodiment of FIG. 5, when the behavior rule is that the vehicle is moving in the opposite direction to the usual direction (meaning the behavior rule is the vehicle is moving backward), and the edge computing device in step S10 determines the behavior of the target object (vehicle) meets the behavior rule (the vehicle is moving backward), the edge computing device outputs the notification in step S13. The notification outputted by the edge computing device preferably includes the message of “the vehicle is moving backward”, so as to notify the personnel of the traffic monitoring center that the vehicle is moving backward.

Please continue referring to FIG. 5 and take the above-mentioned moving direction as the behavior rule for an example. Similarly, when the behavior rule is that the vehicle is moving in the usual direction (meaning the behavior rule is the vehicle is moving forward), and the edge computing device in step S10 determines the behavior of the target object (vehicle) fails to meet the behavior rule (the vehicle is moving forward), the edge computing device outputs the notification in step S13. The notification outputted by the edge computing device preferably includes the message of “the vehicle is moving backward”, so as to notify the personnel of the traffic monitoring center that the vehicle is moving backward.

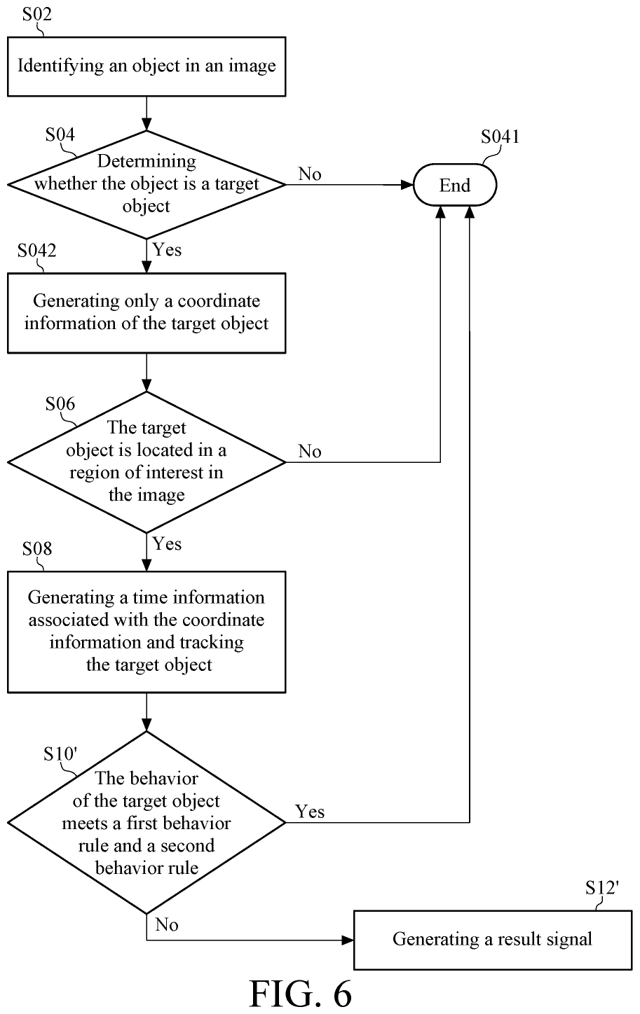

Please refer to FIG. 6. FIG. 6 is a flow chart of an object tracking method based on image according to a fifth embodiment of the present disclosure. Steps S02 to S08 disclosed in FIG. 6 are the same as steps S02 to S08 disclosed in FIG. 2, which won't be further illustrated herein.

FIG. 6 is different from FIG. 2 in that, after tracking the target object in step S08, the edge computing device further determines in step S10′ whether the behavior of the target object meets a first behavior rule and a second behavior rule. When the behavior of the target object in the region of interest fails to meet one of the first behavior rule or the second behavior rule, the edge computing device generates the result signal accordingly in step S12′. Conversely, when the behavior of the target object in the region of interest meets the first behavior rule and the second behavior rule, ends the method of the present embodiment (step S041).

Please continue referring to step S10′ of FIG. 6. In other words, one region of interest can correspond to a plurality of behavior rules. Take the above-mentioned moving direction for example, the first behavior rule is that the vehicle is moving forward, and the second behavior rule is that the vehicle's speed does not exceed an upper limited speed. When the edge computing device determines in step S10′ that the vehicle (target object) in the region of interest is not moving forward (first behavior rule), or its speed exceeds the upper limited speed (second behavior rule), the result signal generated in step S12′ by the edge computing device preferably includes the information of the vehicle that its behavior fails to meet the first behavior rule or the second behavior rule. In addition, the edge computing device can further perform steps S14 to S18 shown in FIG. 5 based on the result signal generated in step S12′, the present disclosure is not limited thereto.

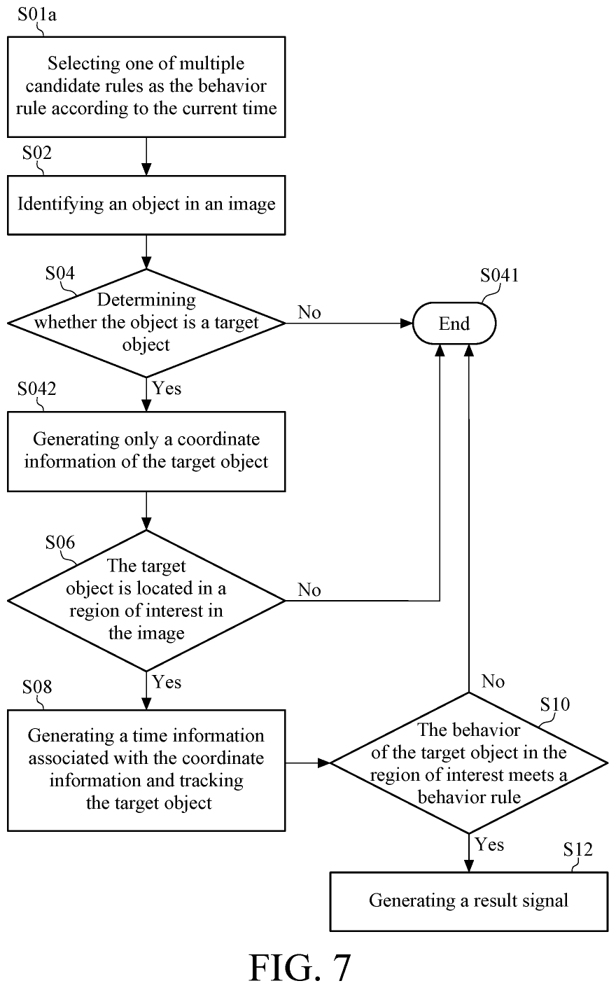

Please refer to FIG. 7. FIG. 7 is a flow chart of an object tracking method based on image according to a sixth embodiment of the present disclosure. Steps S02 to S12 disclosed in FIG. 7 are the same as steps S02 to S12 disclosed in FIG. 4, which won't be further illustrated herein.

FIG. 7 is different from FIG. 4 in that, before identifying the object in the image in step S02, the edge computing device can select one of multiple candidate rules as the behavior rule according to the current time in step S01a.

Please continue referring to step S01a of FIG. 7 and take the above-mentioned moving direction as the behavior rule as an example. The candidate rules can include moving path, dwell time and speed of the target object etc. The candidate rules can correspond to different traffic scenario depends on different timing. For example, the traffic scenario may include merged lanes during rush hours. Therefore, the edge computing device can select one of the candidate rules as the behavior rule that fits the current traffic scenario. The edge computing device can also select more than one candidate rules as the behavior rule, the present disclosure is not limited thereto.

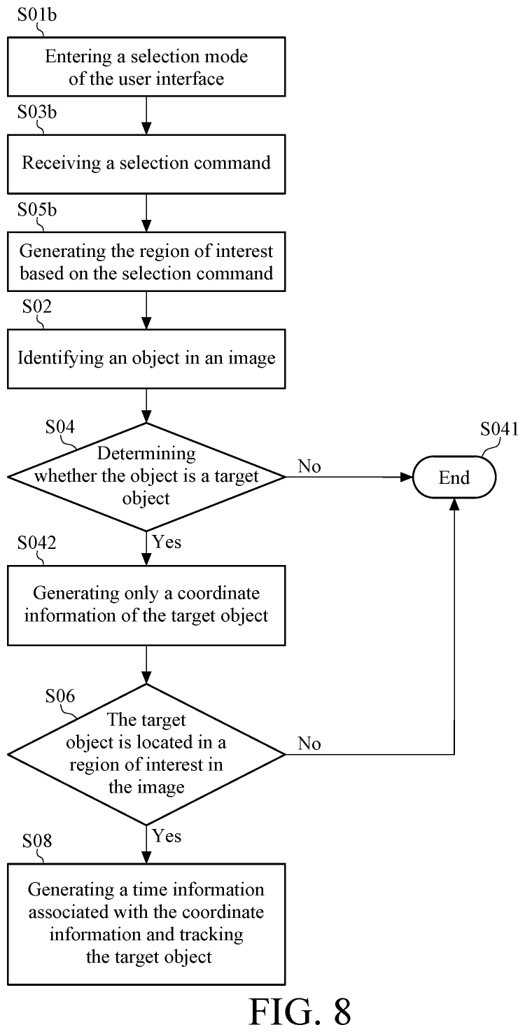

Please refer to FIG. 8. FIG. 8 is a flow chart of an object tracking method based on image according to a seventh embodiment of the present disclosure. Steps S02 to S08 disclosed in FIG. 8 are the same as steps S02 to S08 disclosed in FIG. 2, which won't be further illustrated herein.

FIG. 8 is different from FIG. 2 in that, before identifying the object in the image in step S02, the edge computing device can enter a selection mode of the user interface in step S01b to receive a selection command in subsequent step S03b.

Please continue referring to step S01b and S03b of FIG. 8. Specifically, the selection mode presented by the user interface includes the image for receiving the selection command in subsequent step S03b. The selection command is, for example, inputted by a user, the present disclosure is not limited thereto.

Please refer to step S05b of FIG. 8, wherein after receiving the selection command, the edge computing device can then generate the region of interest based on the selection command. In other words, the selection command is used to assign a selected area, and the edge computing device can use the selected area as the region of interest.

Please continue referring to FIG. 8. In addition, the edge computing device can further perform steps S10 to S18 as shown in FIG. 4 after tracking the target object in step S08. The present disclosure is not limited thereto.

In view of the above description, according to one or more embodiments of the object tracking method based on image of the present disclosure, not only multiple regions of interest may be set up in one monitoring image and have different behavior rules for different regions of interest, the corresponding result signal and/or notification may be generated based on the behavior of the target object for the monitoring center to control the situation of the monitoring site. In addition, according to one or more embodiments of the object tracking method based on image of the present disclosure, the event log corresponding to the behavior rule may be updated based on the result signal. Accordingly, the monitoring system may perform subsequent analysis on the event log stored in the database. In addition, according to one or more embodiments of the object tracking method based on image of the present disclosure, the computational load may be effectively reduced, and the storage capacity of the memory may be prevented from being occupied by unnecessary data.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. An object tracking method based on image, comprising:
identifying an object in an image and determining whether the object is a target object;
determining whether the target object is located within a region of interest in the image when the object is identified as the target object; and
generating a coordinate information and a time information associated with the target object and tracking the target object when the target object is located within the region of interest.

2. The object tracking method based on image according to claim 1, wherein the method further comprises: generating only the coordinate information associated with the target object when the target object is located outside the region of interest.

3. The object tracking method based on image according to claim 1, wherein, when tracking the target object, the method further comprises:
determining whether the behavior of the target object in the region of interest meets a behavior rule; and
generating a result signal when the behavior of the target object meets the behavior rule.

4. The object tracking method based on image according to claim 3, wherein the method further comprises:
counting an event log corresponding to the behavior rule according to the result signal; and
storing the counted event log to a database.

5. The object tracking method based on image according to claim 3, wherein the image has another region of interest, and the two regions of interest are separated from each other.

6. The object tracking method based on image according to claim 1, wherein, when tracking the target object, the method further comprises:
determining whether the behavior of the target object in the region of interest meets a first behavior rule or a second behavior rule, wherein the first behavior rule is different from the second behavior rule; and
generating a result signal when the behavior of the target object in the region of interest fails to meet the first behavior rule or the second behavior rule.

7. The object tracking method based on image according to claim 3, wherein the method further comprises: outputting a notification to a user interface for the user interface to present when the behavior of the target object meets the behavior rule.

8. The object tracking method based on image according to claim 3, wherein the method further comprises: outputting a notification to a user interface for the user interface to present when the behavior of the target object fails to meet the behavior rule.

9. The object tracking method based on image according to claim 3, wherein, before determining whether the behavior of the target object in the region of interest meets the behavior rule, the method further comprises: selecting one of a plurality of candidate rules as the behavior rule according to the current time.

10. The object tracking method based on image according to claim 4, wherein, after storing the counted event log to the database, the method further comprises: outputting the event log stored in the database to a user interface at a predetermined interval for the user interface to present.
